(19) United States
(12) Patent Application Publication
(10) Pub. No.: US 2017/0260077 A1
(43) Pub. Date: Sep. 14, 2017

(54) GLASS FOR CHEMICAL STRENGTHENING AND METHOD FOR MANUFACTURING GLASS FOR CHEMICAL STRENGTHENING, AND CHEMICALLY STRENGTHENED GLASS AND IMAGE DISPLAY DEVICE PROVIDED WITH SAME

(71) Applicant: ASAHI GLASS COMPANY, LIMITED, Chiyoda-ku (JP)

(72) Inventors: Junichiro KASE, Tokyo (JP); Takenori MIURA, Tokyo (JP); Masamichi KAWAKAMI, Tokyo (JP); Junko MIYASAKA, Tokyo (JP)

(73) Assignee: ASAHI GLASS COMPANY, LIMITED, Chiyoda-ku (JP)

(21) Appl. No.: 15/609,610

(22) Filed: May 31, 2017

Related U.S. Application Data
(63) Continuation of application No. PCT/JP2015/083287, filed on Nov. 26, 2015.

(30) Foreign Application Priority Data
Dec. 2, 2014 (JP) 2014-244446

(51) Int. Cl. C03B 18/02; C03C 3/087; C03C 4/18; C03C 21/00

(52) U.S. Cl. CPC C03B 18/02; C03C 21/002; C03C 3/087; C03C 4/18; C03C 2204/00

(57) ABSTRACT

A glass for chemical strengthening that is a float-formed glass for chemical strengthening includes, as represented by mass percentage based on oxides, from 65 to 72% of SiO₂, from 3.6 to 8.6% of Al₂O₃, from 3.3 to 6% of MgO, from 6.5 to 9% of CaO, from 13 to 16% of Na₂O and from 0 to 0.9% of K₂O. In the glass for chemical strengthening, (Na₂O+K₂O)/Al₂O₃ is from 2.2 to 5. The glass for chemical strengthening has a sheet thickness (t) of 0.1 mm or more and 2 mm or less. A SnO₂ amount of a bottom surface in an unpolished state of the glass for chemical strengthening is 6.2 μg/cm² or less (0.1≦t≦1 mm) or (2t+4.2) μg/cm² or less (1<t≦2 mm).

### TECHNICAL FIELD

The present invention relates to a glass for chemical strengthening, favorable as a raw sheet glass for a chemically strengthened glass used in cover glasses and touch sensor glasses of touch panel displays equipped in information instruments such as tablet type terminals, notebook-size personal computers, smartphones and e-book readers, cover glasses of electronic instruments such as cameras, game machines and portable music players, cover glasses of liquid-crystal televisions, personal computer monitors, etc., cover glasses of automobile instrument panels, etc., cover glasses for solar cells, and multilayer glasses for use in windows of buildings and houses, etc., to a method for producing the glass for chemical strengthening, and to a chemically strengthened glass.

### BACKGROUND ART

Recently, as for information instruments, touch panel display-equipped ones have been becoming mainstream, as seen in tablet type terminals, smartphones, e-book readers, etc. The touch panel display has a structure where a touch sensor glass and a cover glass are layered on a glass substrate for a display. There is also known an integrated configuration of a touch sensor glass and a cover glass, which is called OGS (one glass solution).

Any glass of the touch sensor glass, the cover glass and the OGS glass is desired to be thin and have a high strength, and a chemically strengthened glass chemically strengthened by ion exchange has been used.

The strengthening characteristics of these chemically strengthened glasses are generally expressed as a surface compressive stress (CS; compressive stress) and a depth of compressive stress (DOL; depth of layer). In the case where an ordinary soda lime glass is subjected to chemical strengthening treatment as a raw sheet glass, a chemically strengthened glass having CS of 500 to 600 MPa and DOL of 6 to 10 μm is generally obtained.

In addition, in order to enhance the strength, an aluminosilicate glass having an easily ion-exchangeable composition has been proposed, and in the case where the aluminosilicate glass is subjected to the same chemical strengthening treatment as a raw sheet glass, a chemically strengthened glass having CS of 700 to 850 MPa and DOL of 20 to 100 μm is obtained.

These glasses for chemical strengthening are produced according to a float process or a fusion process (also referred to as an overflow downdraw process). The float process is known as a production method for architectural windowpanes and the like, and is a method of casting a molten glass onto molten tin and forming it into a planar form. The other fusion process is known as a production method for alkali-free glasses for displays and the like, and is a method of overflowing a glass down to both sides from an upper gutter and fusing it at a tip of a lower sword to form it into a planar form. For the glass for chemical strengthening, in general, a soda lime glass is produced according to the float process, and the aluminosilicate glass is produced according to both production methods of the float process and the fusion process.

A glass sheet according to the float process is produced with a float production apparatus (comprising a float forming furnace (float bath) for forming into a tabular glass ribbon and an annealing furnace for annealing (cooling) the above-mentioned glass ribbon). The annealed glass ribbon is thereafter cut into a predetermined size.

The soda lime glass produced according to the float process is inexpensive as compared with the aluminosilicate glass. However, regarding the chemically strengthened glass of the conventional soda lime glass, it has been difficult to increase CS to a glass strength level as recently required. Accordingly, there has been proposed a chemical strengthening treatment method that can increase the glass strength in a chemically strengthened glass using the soda lime glass (for example, see Patent Document 1).

### PRIOR ART DOCUMENTS

### Patent Document

Patent Document 1: WO2013/47676

### SUMMARY OF THE INVENTION

### Problems that the Invention is to Solve

According to the method disclosed in Patent Document 1, it requires strictly controlled two-stage chemical strengthening treatment, nitrates having different compositions are used in the first stage treatment and the second stage treatment, and the processing temperatures are also different from each other therebetween. Consequently, the treatment is performed using two strengthening treatment tanks, so that the method is higher in production cost than a conventional one. Therefore, superiority of using the soda lime glass that is inexpensive is lost. In addition, the warpage of a glass after strengthening is increased, because the chemical strengthening treatment is repeated twice. In order to avoid this, it has been necessary to add a step of previously removing a surface layer whose strengthening characteristics are changed by an influence of tin invasion or the like.

On the other hand, in the float process, the glass is formed on the molten tin, and a bottom surface thereof in contact with tin is different in chemical strengthening characteristics from a top surface thereof out of contact with tin. Accordingly, the glass produced according to the float process has a problem that the warpage is liable to occur in the glass after the chemical strengthening step.

An object of the present invention is to provide a glass for chemical strengthening capable of improving the strength more than in a conventional soda lime glass by performing the chemical strengthening treatment similar to conventional one only once and capable of reducing the warpage occurring in the chemical strengthening treatment, and a method for producing the glass for chemical strengthening, and also to provide a chemically strengthened glass and an image display apparatus equipped therewith.

### Means for Solving the Problems

The present inventors have found that it is possible to improve the strength more than that of a conventional soda lime glass and to reduce the warpage occurring in a chemical strengthening step by performing a chemical strengthening treatment similar to conventional one only once, by controlling a SnO₂ amount of a bottom surface in an unpolished state of a glass sheet within a specific range by using a glass having a specific composition and appropriately adjusting production conditions of the glass sheet according to a float process, thus leading to completion of the present invention.

That is, the present invention is as follows.

1. A glass for chemical strengthening that is a float-formed glass for chemical strengthening comprising, as represented by mass percentage based on oxides, from 65 to 72% of SiO₂, from 3.6 to 8.6% of Al₂O₃, from 3.3 to 6% of MgO, from 6.5 to 9% of CaO, from 13 to 16% of Na₂O and from 0 to 0.9% of K₂O, wherein (Na₂O+K₂O)/Al₂O₃ is from 2.2 to 5, and having a sheet thickness (t) of 0.1 mm or more and 2 mm or less, wherein a SnO₂ amount of a bottom surface in an unpolished state of the glass for chemical strengthening is 6.2 μg/cm² or less (0.1≦t≦1 mm) or (2t+4.2) μg/cm² or less (1<t≦2 mm).

2. The glass for chemical strengthening according to the above item 1, wherein R₂−R₁ is 0.0012 or less when a refractive index of the glass for chemical strengthening at room temperature is assumed as R₁ and a refractive index at room temperature after the glass for chemical strengthening heated to a temperature equivalent to or higher than an annealing point is annealed to room temperature at a rate of 1° C./min is assumed as R₂.

3. A glass for chemical strengthening that is a float-formed glass for chemical strengthening comprising, as represented by mass percentage based on oxides, from 65 to 72% of SiO₂, from 3.6 to 8.6% of Al₂O₃, from 3.3 to 6% of MgO, from 6.5 to 9% of CaO, from 13 to 16% of Na₂O and from 0 to 0.9% of K₂O, wherein (Na₂O+K₂O)/Al₂O₃ is from 2.2 to 5, and having a sheet thickness (t) of 0.1 mm or more and 2 mm or less, wherein the glass for chemical strengthening is a glass for chemical strengthening cooled in an annealing furnace of a float production apparatus so that R₂−R₁ is 0.0012 or less when a refractive index of the glass for chemical strengthening at room temperature is assumed as R₁ and a refractive index at room temperature after the glass for chemical strengthening heated to a temperature equivalent to or higher than an annealing point is annealed to room temperature at a rate of 1° C./min is assumed as R₂, and a SnO₂ amount of a bottom surface in an unpolished state thereof is 6.2 μg/cm² or less (0.1≦t≦1 mm) or (2t+4.2) μg/cm² or less (1<t≦2 mm).

4. The glass for chemical strengthening according to any one of the above items 1 to 3, wherein (Na₂O+K₂O+MgO+CaO)/Al₂O₃ is 8.9 or less.

5. The glass for chemical strengthening according to any one of the above items 1 to 4, wherein MgO/(MgO+CaO) is 0.27 or more.

6. The glass for chemical strengthening according to any one of the above items 1 to 5, further comprising, as represented by mass percentage based on oxides, from 0.01 to 0.2% of iron oxide in terms of Fe₂O₃, wherein a redox (Fe²⁺/(Fe²⁺+Fe³⁺)×100) is 18% or more and 35% or less.

7. A method for producing a glass for chemical strengthening, the method comprising melting a glass, float-forming the molten glass into a glass sheet, and thereafter annealing the glass sheet, so as to obtain the glass for chemical strengthening according to any one of the above items 1 to 6.

8. A chemically strengthened glass obtained by chemically strengthening the glass for chemical strengthening according to any one of the above items 1 to 6.

9. An image display apparatus equipped with the chemically strengthened glass according to the above item 8.

10. A method for producing a glass for chemical strengthening, the method comprising a melting step of melting a glass comprising, as represented by mass percentage based on oxides, from 65 to 72% of SiO₂, from 3.6 to 8.6% of Al₂O₃, from 3.3 to 6% of MgO, from 6.5 to 9% of CaO, from 13 to 16% of Na₂O and from 0 to 0.9% of K₂O, wherein (Na₂O+K₂O)/Al₂O₃ is from 2.2 to 5, a forming step of forming the molten glass into a glass ribbon having a sheet thickness (t) of 0.1 mm or more and 2 mm or less with a float production apparatus, an annealing step of annealing the glass ribbon formed, and a cutting step of cutting the glass ribbon annealed, wherein in the forming step, forming is performed in a float forming furnace so that a SnO₂ amount of a bottom surface in an unpolished state of the glass is 6.2 μg/cm² or less (0.1≦t≦1 mm) or (2t+4.2) μg/cm² or less (1<t≦2 mm), and in the annealing step, cooling is performed in an annealing furnace so that R₂−R₁ is 0.0012 or less when a refractive index of the glass at room temperature is assumed as R₁ and a refractive index at room temperature after the glass heated to a temperature equivalent to or higher than an annealing point is annealed to room temperature at a rate of 1° C./min is assumed as R₂.

11. The method for producing a glass for chemical strengthening according to the above item 10, wherein the glass further comprises, as represented by mass percentage based on oxides, from 0.01 to 0.2% of iron oxide in terms of Fe₂O₃, and in the melting step, the glass is melted so that (Fe²⁺/(Fe²⁺+Fe³⁺)×100) is 18% or more and 35% or less.

12. The method for producing a glass for chemical strengthening according to the above item 10 or 11, wherein (Na₂O+K₂O+MgO+CaO)/Al₂O₃ is 8.9 or less.

13. The method for producing a glass for chemical strengthening according to any one of the above items 10 to 12, wherein MgO/(MgO+CaO) is 0.27 or more.

### Advantageous Effects of the Invention

The glass for chemical strengthening of the present invention has a specific composition, and particularly, contents of Al₂O₃ and (Na₂O+K₂O) fall within specific ranges. In addition, a SnO₂ amount of a bottom surface in an unpolished state of the glass for chemical strengthening is controlled within a specific range. Accordingly, a CS value is effectively increased by one chemical strengthening treatment, while the warpage occurring by chemical strengthening can be reduced, and a devitrification temperature and a high-temperature viscosity can be prevented from increasing, which makes it possible to easily produce the glass in a float furnace for a soda lime glass.

### BRIEF DESCRIPTION OF THE DRAWINGS

FIG. 1 is a graph showing a relationship between a thickness of a glass sheet and a bottom surface SnO₂ concentration.

FIG. 2 is a graph showing a correlation between CS×DOL and warpage.

### MODE FOR CARRYING OUT THE INVENTION

In the following, the glass for chemical strengthening of the present invention and the chemically strengthened glass produced by applying a chemical strengthening treatment to the glass for chemical strengthening are collectively called the glass of the present invention. Further, in the present description, a glass produced (formed) according to a float process (float-formed glass) is also referred to as a float glass. In addition, a glass for chemical strengthening produced (formed) according to a float process (float-formed glass for chemical strengthening) is also referred to as a float glass for chemical strengthening.

### <Glass for Chemical Strengthening>

An embodiment of the present invention is described below. The glass for chemical strengthening of the present embodiment is characterized in that it contains, as represented by mass percentage based on oxides, from 65 to 72% of SiO₂, from 3.6 to 8.6% of Al₂O₃, from 3.3 to 6% of MgO, from 6.5 to 9% of CaO, from 13 to 16% of Na₂O and from 0 to 0.9% of K₂O, wherein (Na₂O+K₂O)/Al₂O₃ is from 2.2 to 5.

The reason why a glass composition of the glass for chemical strengthening of the present embodiment is defined to be within the above-mentioned range is described below.

The present inventors have investigated a relationship between the glass composition of the glass formed according to the float process and an invasion amount of tin in the bottom surface, and have found that the content of Al₂O₃ in the glass has an influence on the invasion of tin to have a function of inhibiting the invasion of tin when the Al₂O₃ component is increased. When tin invades in the bottom surface, mainly DOL is liable to be reduced. In addition, Al₂O₃ has a function of improving ion exchangeability in chemical strengthening, and especially a function of improving CS is great. Also, it improves weather resistance of the glass. Furthermore, it has a function of enhancing dealkalization when SO₂ treatment is performed.

The content of Al₂O₃ is 3.6% or more, preferably 3.9% or more, more preferably 4.2% or more, and even more preferably 4.5% or more. In addition, the content of Al₂O₃ is 8.6% or less, more preferably 8% or less, even more preferably 7.5% or less, and particularly preferably 7% or less. When the content of Al₂O₃ is 3.6% or more, an effect of inhibiting the invasion of tin becomes remarkable, and a desired CS value is obtained through ion exchange to obtain an effect of mainly CS stability to changes in a water content of a top surface of a glass ribbon in a float bath and an effect of enhancing dealkalization. On the other hand, when the content of Al₂O₃ is 8.6% or less, a viscosity of the glass is not excessively increased, and a devitrification temperature does not largely rise to the viscosity, which is therefore advantageous in terms of melting and forming in a soda lime glass production line.

SiO₂ is known as a component to form a network structure in a glass microstructure, and is a main component to constitute the glass. The content of SiO₂ is 65% or more, preferably 66% or more, more preferably 66.5% or more, and even more preferably 67% or more. In addition, the content of SiO₂ is 72% or less, preferably 71.5% or less, and more preferably 71% or less. When the content of SiO₂ is 65% or more, it is advantageous in terms of stability and weather resistance as the glass. On the other hand, when the content of SiO₂ is 72% or less, it is advantageous in terms of meltability and formability.

MgO is a component that stabilizes the glass, and is essential. The content of MgO is 3.3% or more, preferably 3.6% or more, and more preferably 3.9% or more. In addition, the content of MgO is 6% or less, preferably 5.7% or less, and more preferably 5.4% or less. When the content of MgO is 3.3% or more, meltability at a high temperature is improved, and devitrification becomes less likely to occur. On the other hand, when the content of MgO is 6% or less, the devitrification remains unlikely, and a sufficient ion-exchanging rate is obtained.

CaO is a component that stabilizes the glass, and is essential. The content of CaO is 6.5% or more, preferably 6.7% or more, more preferably 6.8% or more, and even more preferably 6.9% or more. In addition, the content of CaO is 9% or less, preferably 8.5% or less, more preferably 8.2% or less, even more preferably 8% or less, and yet more preferably 7.7% or less. When the content of CaO is 6.5% or more, the meltability at a high temperature is improved, and the devitrification becomes less likely to occur. On the other hand, when the content of CaO is 9% or less, the sufficient ion-exchanging rate is obtained, and desired DOL is obtained.

The alkaline earth metals, namely MgO and CaO, are components that inhibit ion exchange of alkali metals. However, MgO has extremely small influence on ion exchange inhibition as compared with CaO. The ratio of MgO/(MgO+CaO) is preferably 0.27 or more, more preferably 0.29 or more, and even more preferably 0.31 or more. On the other hand, when a ratio of MgO to CaO is too large, a slope of a glass viscosity curve to temperature becomes gentle. Therefore, a high-temperature viscosity (T₂ or T₄ described later) is increased, and a low-temperature viscosity (the strain point or T_{g} described later) is decreased. As a result, melting and forming become difficult, and at the same time, stress relaxation at the chemical strengthening temperature becomes liable to occur. The ratio of MgO/(MgO+CaO) is preferably 0.48 or less, more preferably 0.46 or less, and even more preferably 0.44 or less.

Na₂O is an essential component that forms a surface compressive stress layer through ion exchange, and has a function of increasing DOL. In addition, it is a component that lowers the high-temperature viscosity and the devitrification temperature of the glass, and improving the meltability and formability of the glass. Na₂O is a component that produces non-bridge oxygen (NBO), and decreases fluctuation of the chemical strengthening characteristics when a water content changes.

The content of Na₂O is 13% or more, preferably 13.4% or more, and more preferably 13.8% or more. In addition, the content of Na₂O is 16% or less, preferably 15.6% or less, and more preferably 15.2% or less. When the content of Na₂O is 13% or more, a desired surface compressive stress layer can be formed through ion exchange, and fluctuation with respect to changes in the water content is also inhibited. On the other hand, when the content of Na₂O is 16% or less, sufficient weather resistance is obtained, and a thermal expansion coefficient is not excessively increased. It is therefore possible to prevent the warpage of the glass after the chemical strengthening treatment.

K₂O has an effect of increasing the ion-exchanging rate and increasing DOL, and is a component that increase non-bridge oxygen. Therefore, it may be contained within a range of 0.9% or less. In the case of 0.9% or less, DOL is not excessively increased, and sufficient CS is obtained. When K₂O is contained, the content thereof is preferably 0.9% or less, more preferably 0.7% or less, and even more preferably 0.5% or less. In addition, a small amount of K₂O has an effect of inhibiting the invasion of tin from the bottom surface during float forming. It is therefore preferred that K₂O is contained during float forming. In this case, the content of K₂O is preferably 0.05% or more, more preferably 0.1% or more, even more preferably 0.15% or more, and yet more preferably 0.2% or more.

Al₂O₃ has a function of increasing CS, while Na₂O has a function of increasing DOL and simultaneously lowering CS. In addition, K₂O has a function of increasing the ion-exchanging rate and increasing DOL. Accordingly, when Al₂O₃, Na₂O and K₂O are contained in a specific ratio, it becomes possible to increase the CS value by the chemical strengthening treatment. The ratio of (Na₂O+K₂O)/Al₂O₃ is 5 or less, preferably 4.5 or less, and more preferably 4 or less.

Al₂O₃ is a component of increasing the devitrification temperature and the high-temperature viscosity, while Na₂O and K₂O are components of lowering both the two. When (Na₂O+K₂O)/Al₂O₃ is less than 2.2, the devitrification temperature is increased, and the high-temperature viscosity is also increased. In addition, DOL may become shallow beyond necessity. For stably producing the glass without increasing the glass melting temperature more than necessary and without causing the devitrification, and for maintaining DOL necessary for improving the strength in chemical strengthening, the ratio of (Na₂O+K₂O)/Al₂O₃ is preferably 2.2 or more, more preferably 2.4 or more, and even more preferably 2.6 or more.

In addition, the present inventors have float-formed glasses having many kinds of compositions, and have tested and evaluated a relationship between the invasion of tin and combined compositions. As a result, in the present invention, it has been found that when (Na₂O+K₂O+MgO+CaO)/Al₂O₃ is preferably 8.9 or less, the invasion of tin in the bottom surface is better inhibited. (Na₂O+K₂O+MgO+CaO)/Al₂O₃ is more preferably 8 or less, even more preferably 7.5 or less, and yet more preferably 7 or less. On the other hand, in order to prevent the high-temperature viscosity from being increased more than necessity, it is preferably 3.8 or more, more preferably 4.4 or more, and even more preferably 5 or more.

Furthermore, in the present invention, it has been found that when (Na₂O+CaO)/Al₂O₃ is preferably 6.9 or less, more preferably 6 or less, even more preferably 5.5 or less, and yet more preferably 5 or less, the invasion of tin is further inhibited. In addition, in order to prevent the high-temperature viscosity from being increased more than necessity, it is preferably 3.3 or more, more preferably 3.8 or more, and even more preferably 4.2 or more.

Fe₂O₃ exists anywhere in nature and in production lines, and therefore it is a component extremely difficult to make the content thereof zero. It is known that Fe₂O₃ in an oxidized state causes coloration in yellow and that FeO in a reduced state causes coloration in blue, and glass colors in green depending on a balance of the two. When the glass of the present embodiment is used for displays, windowpanes and solar uses, deep coloring thereof is undesirable. When a total iron amount (total Fe) is converted to Fe₂O₃, the content thereof is preferably 0.2% or less, more preferably 0.15% or less, and even more preferably 0.13% or less. In addition, the content thereof is preferably 0.01% or more, and more preferably 0.015% or more.

Especially, when the glass of the present embodiment is used for displays, blue coloration caused by FeO is undesirable for keeping a transmission color in a natural color tone. In addition, when used for solar uses, an infrared ray absorption due to FeO is undesirable. For this reason, the glass in which the amount of FeO is small is preferred. A ratio of FeO and Fe₂O₃ in the glass is generally expressed as the redox (Fe²⁺/(Fe²⁺+Fe³⁺)×100(%)). The redox of the glass depends mainly on a melting temperature of the glass, and it increases when melted at a high temperature and lowers when melted at a low temperature. In order to suppress the color tone and the infrared ray absorption, the redox of the glass is preferably 35% or less, more preferably 32% or less, and even more preferably 30% or less. When the melting temperature is excessively lowered, defects of bubbles or unmelted materials in the glass increase, and therefore, the redox of the glass is preferably 18% or more, more preferably 21% or more and even more preferably 23% or more.

In the present invention, it is preferred that glass raw materials are melted in a melting furnace to a molten glass in such a manner that the redox of the glass falls within the above-mentioned range.

In addition to this, a sulfate, a chloride, a fluoride or the like may be suitably contained as a refining agent for glass melting. When the sulfate is contained, the content of SO₃ in the glass is preferably 0.02% or more, more preferably 0.05% or more, and even more preferably 0.1% or more. In addition, the content of SO₃ is preferably 0.4% or less, more preferably 0.35% or less, and even more preferably 0.3% or less. When the content of SO₃ is 0.02% or more, the glass can be sufficiently refined to remove babble defects. On the other hand, when the content of SO₃ is 0.4% or less, defects of sodium sulfate formed in the glass can be inhibited.

The glass of the present invention is essentially formed of the above-mentioned components but may contain any other component within a range not detracting from the object of the present invention. When such components are contained, a total content of the components is preferably 3% or less, more preferably 2% or less, even more preferably 1% or less, and yet more preferably 0.5% or less. The above-mentioned other components will be exemplarily described below.

B₂O₃ may be contained within a range of 2% or less to improve the meltability at a high temperature or the strength of the glass. In general, when B₂O₃ is contained together with an alkali component of Na₂O or K₂O, evaporation thereof may vigorously occur to greatly corrode bricks. It is therefore preferred that B₂O₃ is not substantially contained. The expression “is not substantially contained” means that it is not contained except the case where it is contained as unavoidable impurities, and the same applies hereinafter.

SrO and BaO are not essential, but may be contained in small amounts for the purpose of lowering the high-temperature viscosity of the glass and lowering the devitrification temperature thereof. SrO or BaO has a function of lowering the ion-exchanging rate, and therefore, when contained, the SrO or BaO amount is preferably 1% or less, and more preferably 0.5% or less. The total amount of SrO and BaO is preferably 1% or less, and more preferably 0.5% or less.

TiO₂ much exists in natural resources, and acts as a coloring source of yellow. When TiO₂ is contained, the content thereof is preferably 0.5% or less, more preferably 0.2% or less, even more preferably 0.15% or less, and yet more preferably 0.1% or less. When the content of TiO₂ is 0.5% or less, a phenomenon that the glass becomes yellowish can be avoided.

ZnO may be contained, for example, in an amount of up to 2% for improving the meltability of the glass at a high temperature. However, in the case of production according to the float process, it is reduced in the float bath to cause product defects. Therefore, the content thereof is preferably 0.5% or less, and it is more preferably not substantially contained.

ZrO₂ is a composition that increases CS after chemical strengthening. When ZrO₂ is contained, the content thereof is preferably 2% or less, more preferably 1% or less, and even more preferably 0.5% or less. When the content of ZrO₂ is 2% or less, an increase in the devitrification temperature can be avoided. When it is desired to inhibit an increase in the high-temperature viscosity, it is preferred that ZrO₂ is not substantially contained except mixed from a furnace material.

Li₂O is a component of lowering T_{g} to facilitate stress relaxation, thereby making it difficult to obtain a stable surface compressive stress layer. It is therefore preferably not substantially contained. Even when contained, the content thereof is preferably less than 1%, more preferably 0.1% or less, and particularly preferably less than 0.01%.

The glass of the present embodiment is characterized in that it can be readily converted from an ordinary soda lime glass from a viewpoint of both production characteristics and product characteristics. Regarding the ordinary soda lime glass, the temperature (T₂) for log η=2, which is a basis of the high-temperature viscosity in glass melting, is generally from 1445 to 1475° C., wherein the unit of viscosity η is dPa·s

When an increase in the high-temperature viscosity in melting is within a range of up to about +50° C., the glass of the present embodiment can be readily produced in a melting furnace in which the ordinary soda lime glass is melted. Regarding the high temperature viscosity in melting the glass of the present invention, T₂ is preferably 1520° C. or lower, and more preferably 1500° C. or lower.

Regarding the ordinary soda lime glass, a temperature (T₄) for log η=4, which is a basis of the high-temperature viscosity in glass forming according to the float process, is generally from 1020 to 1050° C. When an increase in the high-temperature viscosity at the temperature giving this viscosity is within a range of up to about +30° C., the glass of the present embodiment can be readily produced with a float production apparatus in which the ordinary soda lime glass is formed. Regarding the high-temperature viscosity in forming the glass of the present invention, the temperature for log η=4 is preferably 1080° C. or lower and more preferably 1060° C. or lower.

When the glass is produced according to the float process, a devitrification temperature (T_{L}) is compared with the above-mentioned T₄ to make a judgment about a risk of the devitrification. In general, when the glass has a devitrification temperature equal to or lower than a temperature that is higher by 15° C. than T₄, it can be produced according to the float process without causing the devitrification, and preferably, it is T₄ or lower. That is, T₄−T_{L} is −15° C. or higher, and preferably 0° C. or higher.

The ordinary soda lime glass has a specific gravity at room temperature of from 2.490 to 2.505. In consideration of a case where the glass of the present embodiment and the ordinary soda lime glass are alternately produced with the same production equipment (melting furnace and float production apparatus), when fluctuation in specific gravity is preferably 0.03 or less and more preferably 0.01 or less, a composition change is easy. The specific gravity of the glass of the present embodiment is preferably 2.480 or more and 2.515 or less.

Regarding a temperature for performing the chemical strengthening treatment, an effective treatment temperature can be determined on the basis of the strain point of the glass. In general, the chemical strengthening treatment is carried out at a temperature that is lower by 50 to 100° C. than the strain point. The strain point of the ordinary soda lime glass is from 490 to 520° C.

The same chemical strengthening treatment as the conventional one is applied to the glass of the present embodiment, and therefore, the strain point thereof is preferably from 480 to 540° C., and more preferably from 490 to 530° C. A highly skilled technique is necessary for strain point measurement. Therefore, a glass transition point T_{g} is determined by measuring a thermal expansion coefficient, and this may be used as a substitute. In general, T_{g} is a temperature that is higher by about 40° C. than the strain point. T_{g} of the glass of the present embodiment is preferably from 520 to 580° C., and more preferably from 530 to 570° C.

The thermal expansion coefficient of the ordinary soda lime glass is generally a value of from 85×10⁻⁷ to 93×10⁻⁷° C.⁻¹ within a temperature range of from 50 to 350° C. A glass for displays becomes a product for information instruments and the like via various steps such as film formation and lamination. In that case, it is desired that the thermal expansion coefficient does not greatly vary from the conventional value. The thermal expansion coefficient of the glass of the present embodiment is preferably from 83×10⁻⁷ to 95×10⁻⁷° C.⁻¹, and more preferably from 85×10⁻⁷ to 93×10⁻⁷° C.⁻¹.

### <Production of Glass for Chemical Strengthening>

The glass for chemical strengthening of the present embodiment is a glass sheet formed according to the float process. In addition, it may be a glass sheet subjected to bending processing after formed into a tabular form. The glass for chemical strengthening (glass sheet) of the present embodiment is a glass sheet having a sheet thickness (t) of 0.1 mm or more and 2 mm or less and produced under such conditions that a SnO₂ amount of a bottom surface in an unpolished state of the glass sheet is 6.2 μg/cm² or less (0.1≦t≦1 mm) or (2t+4.2) μg/cm² or less (1<t≦2 mm). In addition, the glass is preferably one produced under such conditions that when a refractive index of the glass for chemical strengthening at room temperature (for example, 25° C.) is assumed as R₁ and a refractive index of the glass for chemical strengthening after the glass for chemical strengthening heated to a temperature equivalent to or higher than an annealing point is annealed to room temperature (for example, 25° C.) at a rate of 1° C./min is assumed as R₂, R₂−R₁ is 0.0012 or less. Furthermore, the glass is preferably one produced under such conditions that a redox (Fe²⁺/(Fe²⁺+Fe³⁺)×100(%)) is 18% or more and 35% or less.

The glass for chemical strengthening of the present embodiment is formed according to the float process, and first, a continuous ribbon-shaped glass having a float forming width is obtained. Thereafter, it is cut into a size suitable for transportation or a chemical strengthening treatment, and finally cut into a size suitable for the intended use. That is, it may have a size of displays of tablet type terminals, smartphones or the like, or a size of windowpanes of buildings or houses. For the displays, a short side thereof has a size of 45 mm or more, and for the windowpanes, a short side thereof has a size of 200 mm or more. In addition, for immersing in a chemical strengthening tank, a long side is preferably 2000 mm or less. The glass of the present embodiment is generally cut into a rectangular form, but may also be in any other form such as a circular form or a polygonal form with no problem, including a perforated glass.

In the glass formed according to the float process, the warpage occurs after chemical strengthening and is liable to impair a flatness. The warpage occurs due to a difference in behavior of chemical strengthening between a top surface that is a glass surface out of contact with molten tin at the time of float forming and a bottom surface that is a glass surface in contact with molten tin.

As described above, when the Al₂O₃ amount in the glass composition is increased, the invasion of tin in the bottom surface is inhibited. Tin invades in the bottom surface during the glass ribbon passes through the float bath. Therefore, the invasion amount thereof also depends on a temperature of the float bath, an atmosphere of an upper portion of the bath, a purity of molten tin, a passing time of the glass and the like.

The float forming of the soda lime glass is usually performed at a temperature of about 1050° C. at an inlet of the bath and at a temperature of about 600° C. at an outlet of the bath. In the formation of a thin sheet of 2 mm or less, adjustment to a thin thickness is performed by pulling the glass ribbon to a drawing direction while preventing a decrease in width with an assist roll holding both ends of the glass ribbon. The glass of the present embodiment can be formed at the same temperature as the soda lime glass. That is, the temperature is preferably from 1020 to 1100° C. at the inlet of the bath, and preferably from 570 to 650° C. at the outlet of the bath.

A float bath passing speed of the glass ribbon, namely a bath residence time, is usually from 15 to 60 minutes. However, in order to suppress to low the tin invasion in the bottom surface, it is preferred to more shorten the time. The bath residence time is preferably 12 minutes or less, more preferably 10 minutes or less, even more preferably 8 minutes or less, and particularly preferably 7 minutes or less.

Regarding the glass sheet of the present embodiment, the sheet thickness (t) is 0.1 mm or more and 2 mm or less, and the SnO₂ amount of the bottom surface in the unpolished state is 6.2 μg/cm² or less (0.1≦t≦1 mm) or (2t+4.2) μg/cm² or less (1<t≦2 mm), by realizing the above-mentioned preferred residence time. The SnO₂ amount of the bottom surface in the unpolished state is more preferably 5.9 μg/cm² or less (0.1≦t≦1 mm) or (2t+3.9) μg/cm² or less (1<t≦2 mm), and even more preferably 5.6 μg/cm² or less (0.1≦t≦1 mm) or (2t+3.6) μg/cm² or less (1<t≦2 mm).

The SnO₂ amount of the bottom surface is determined by measuring a Sn content per unit area. Specifically, for example, it can be determined by etching the bottom surface by 10 μm or more with a hydrofluoric acid solution, and quantifying a Sn concentration in the solution through ICP emission spectrometry. SnO₂ invades to a depth of several μm from the bottom surface. Therefore, when etched by 10 μm or more from the bottom surface, an almost constant value is obtained. A profile in a depth direction of SnO₂ invasion is in a constant form, and therefore, it can be determined using a calibration curve also through X-ray fluorescence analysis of the bottom surface.

The glass of the present embodiment exhibits an effect of being able to reduce the warpage at the time of chemical strengthening, because the invasion amount of SnO₂ is small even when it comes into contact with the molten tin, and the difference in the chemical strengthening characteristics between the top surface and the bottom surface of the float glass is small. Even when the glass of the present embodiment is formed into a thin sheet, the warpage after the chemical strengthening treatment is decreased thereby. In addition, by treating the chemical strengthening treatment, the warpage is decreased and the strength is increased.

The soda lime glass is usually melted at a temperature of about 1500° C. as a maximum temperature in a melting furnace. In general, the above-mentioned T₂ increases with an increase in the content of Al₂O₃ in glass. It is therefore necessary to increase the melting temperature of glass. However, in the glass of the present embodiment, the contents of Al₂O₃ and (Na₂O+K₂O) are increased in good balance. Therefore, T₂ does not increase, and it can be melted at the same temperature as the ordinary soda lime glass.

As described above, the redox increases with an increase in the melting temperature of glass. In the production method of the glass of the present embodiment, in order to inhibit blue coloration or infrared ray absorption, the maximum temperature of melting is preferably 1560° C. or lower, more preferably 1540° C. or lower, and even more preferably 1520° C. or lower. Further, in order to prevent defects such as bubbles or unmelted materials from occurring in the glass, it is preferably 1440° C. or higher, and more preferably 1460° C. or higher.

Regarding the glass sheet of the present embodiment, the redox of the glass is 35% or less, preferably 32% or less, and more preferably 30% or less, by realizing the above-mentioned preferred melting temperature. The redox of the glass is 18% or more, preferably 21% or more, and more preferably 23% or more.

The redox of the glass can be determined by quantifying Fe²⁺ through bipyridyl absorptiometry and calculating Fe²⁺/(Fe²⁺+Fe³⁺) from the value of total Fe₂O₃ determined by X-ray fluorescence analysis. In addition to this, it is also possible to determine an infrared absorption coefficient (Fe²⁺) and a UV absorption coefficient (F³⁺) by measurement using a spectrophotometer, and then to calculate the redox therefrom.

The redox of the glass, namely a valence number of the Fe ion, does not become an accurate index of the melting temperature in a situation where multivalent ions such as As, Sb, Ce and Sn coexist. When these ions coexist, the valence number of the Fe ion varies according to thermal history of temperature rise and temperature fall. In addition, analysis of the redox also becomes inaccurate. In the glass of the present embodiment, the contents of components such as As₂O₃, Sb₂O₃, CeO₂ and SnO₂ are sufficiently small as compared with Fe₂O₃, and it is a glass substantially having no influence on a change in the valence number of the Fe ion. SnO₂ invading in the bottom surface is 50 ppm or less in concentration in the glass sheet as a whole, and is sufficiently small as compared with Fe₂O₃.

Regarding the glass for chemical strengthening of the present embodiment, in order to more increase a CS value according to the chemical strengthening treatment, it is preferred that a fictive temperature of the glass is lowered. Atoms in glass are arranged in a structure under a liquid phase state, and a temperature at which this structure has been frozen is referred to as the fictive temperature. The fictive temperature of the glass depends on a cooling rate from the annealing point of the glass to near 200° C., and the fictive temperature is lowered by slow annealing to increase a density, even when the glass has the same composition. When the density of the glass is increased, the compressive stress generated by ion exchange is more increased. Therefore, the CS value is increased.

The glass of the present embodiment is the glass produced according to the float process, and is annealed through a long annealing furnace as compared with a fusion process. After passing through an inlet of a lehr (annealing furnace) after the outlet of the float bath, the cooling rate from the annealing point of the glass to near 200° C. (preferably 200° C. or lower) is preferably 200° C./min or less, more preferably 130° C./min or less, and even more preferably 80° C./min or less, considering that the above-mentioned glass fictive temperature is reduced.

A change in the fictive temperature of the glass can be estimated by a change in the refractive index of the glass, as a simplified method. First, the refractive index (R₁) of a formed glass sheet at room temperature (for example, 25° C.) is measured. Furthermore, the glass sheet is heated at a temperature equivalent to or higher than the annealing point, and annealed to room temperature (for example, 25° C.) at a rate of 1° C./min (hereinafter also referred to as re-annealing treatment). Thereafter, the refractive index (R₂) of the glass sheet at room temperature is measured again. Then, by the difference (R₂−R₁) between the refractive indexes measured before and after the re-annealing treatment, it can be known that the fictive temperature of the formed glass sheet has been in how high a state with respect to the fictive temperature when cooled at 1° C./min.

Regarding refractive index measurement of glass, there have been known an angle of minimum deviation method, a critical angle method, a V-block method and the like, and any of the measurement methods may be used for verification of the effect of the present invention. Regarding the glass for chemical strengthening of the present embodiment, the difference (R₂−R₁) between the refractive indexes before and after the re-annealing treatment is preferably 0.0012 or less, more preferably 0.0011 or less, and even more preferably 0.0010 or less. When the difference between the refractive indexes is 0.0012 or less, the fictive temperature of the glass sheet is lowered, resulting in a remarkable increase in CS.

In the present invention, as described above, it is preferred that the cooling rate of the glass ribbon from the annealing point to near 200° C. in the annealing furnace is slow (corresponding to that the conveying speed of the glass ribbon in the annealing furnace is substantially slow). Herein, the glass ribbon is continuously conveyed from the float bath to the annealing furnace, and therefore, that the above-mentioned cooling rate is slow corresponds to that the conveying speed of the glass ribbon in the float bath is slow. When the conveying speed of the glass ribbon in the float bath is slow, the invasion amount of tin in the bottom surface of the glass ribbon tends to increase. However, in the present invention, since the invasion amount of tin is suppressed, the influence thereof is small. That is, in the present invention, even when the fictive temperature of the glass is low (for example, even when the difference between the refractive indexes before and after the above-mentioned re-annealing treatment is 0.0012 or less), the invasion amount of tin is suppressed (specifically, the SnO₂ amount of the unpolished bottom surface is 6.2 μg/cm² or less (0.1≦t≦1 mm) or (2t+4.2) μg/cm² or less (1<t≦2 mm)).

In addition to this, production may be performed in combination with a surface treatment technique for reducing the warpage of the glass after chemical strengthening. Specifically, a dealkalization treatment is performed onto a surface layer of the top surface to decrease ion-exchange ability of the top surface, and stress of the top surface generated by chemical strengthening is balanced with stress of the bottom surface, thereby being able to reduce the warpage.

As a technique of the dealkalization of the top surface of the glass sheet formed according to the float process, it is effective to treat the surface layer of the top surface with an acidic gas in the float bath or the lehr. The acidic gases include at least one acidic gas selected from SO₂ gas, HCl gas and HF gas, and a mixed gas containing at least one acidic gas selected therefrom.

The glass for chemical strengthening of the present invention is obtained by melting raw materials in a melting furnace to a molten glass so as to achieve a predetermined glass composition, and forming it into a tabular glass ribbon in a float forming furnace (float bath), followed by annealing (cooling) in an annealing furnace. Thereafter, it is cut into a predetermined size.

The sheet thickness t of the glass sheet in the glass for chemical strengthening of the present invention is 0.1 mm or more, preferably 0.2 mm or more, and more preferably 0.3 mm or more. In addition, the sheet thickness t of the glass sheet is 2 mm or less, preferably 1.8 mm or less, more preferably 1.6 mm or less, even more preferably 1.4 mm or less, yet more preferably 1.2 mm or less, and yet still more preferably 1 mm or less.

When the sheet thickness t of the glass sheet is 0.1 mm or more, a sufficient effect of increasing the strength is obtained by the chemical strengthening treatment described later. When the sheet thickness t of the glass sheet is 2 mm or less, it becomes possible to remarkably increase the strength by chemical strengthening, although an increase in the strength by a physical strengthening cannot be expected.

### <Chemical Strengthening Treatment>

The chemical strengthening treatment of the present embodiment can be performed by a conventionally known chemical strengthening treatment method. In addition, before the chemical strengthening treatment, shape processing according to the use, for example, machining such as cutting, edge processing and hole making or bending may be performed.

According to the chemical strengthening treatment, the glass sheet is brought into contact with a melt of an alkali metal salt (for example, a potassium nitrate salt) containing an alkali metal ion having a large ion radius (typically, K ion) by immersion or the like, thereby substituting a metal ion having a small ion radius (typically, Na ion) in the glass sheet with the metal ion having a large ion radius.

The chemical strengthening treatment can be performed, for example, by immersing the glass sheet in a molten salt of potassium nitrate at 340 to 550° C. for 5 minutes to 24 hours. Regarding ion exchange conditions, optimum conditions may be selected, considering the viscosity characteristics of glass, the use, the sheet thickness, the tensile stress in the inside of glass and the like.

The molten salts for performing the ion exchange treatment include, for example, alkali nitrate salts, alkali sulfate salts, alkali chloride salts and the like, such as a potassium nitrate salt, a potassium sulfate salt and a potassium chloride salt. These molten salts may be used either alone or in combination of plural kinds thereof. In addition, in order to adjust the chemical strengthening characteristics, a sodium-containing salt may be mixed.

In the present invention, treatment conditions of the chemical strengthening treatment is not particularly limited, and optimum conditions may be selected considering the characteristics of the glass, the molten salt and the like.

### <Chemically Strengthened Glass>

The chemically strengthened glass (chemically strengthened glass product) can be obtained by chemically strengthening the glass for chemical strengthening of the present invention. The chemically strengthened glass products include cover glasses of display apparatus and the like, multilayer glasses for use in windows of buildings and houses, and the like.

For example, in the case of a glass sheet having a sheet thickness of 0.7 mm or 1.1 mm and having been chemically strengthened so as to have DOL of 8 μm or more, which is one of the most preferred case in the present embodiment, the CS value thereof is 700 MPa or more in one-time chemical strengthening using a high-purity potassium nitrate salt having a purity of 99.8% or more, preferably 730 MPa or more, and more preferably 760 MPa or more. In chemical strengthening in a scale of mass production, for example, in chemical strengthening with a potassium nitrate salt having a purity of 98%, it is 560 MPa or more, preferably 590 MPa or more, and more preferably 620 MPa or more. When the glass is cut after the chemical strengthening treatment, it is preferably 900 MPa or less, and more preferably 850 MPa or less.

In the present invention, the nitrate salt to be used in confirming an increase in CS is preferably high-purity potassium nitrate having a purity of 99.5% or more. When the nitrate salt after repeated use is used, there is a concern that not only the CS value may be lowered, but also the effect of increasing CS would become unclear by an influence of sodium and the like introduced thereinto.

In the case of measuring a chemical strengthening stress, the measurement of a surface stress becomes inaccurate when DOL is shallow. In chemical strengthening for confirming an increase in CS, DOL is preferably 8 μm or more. In the chemical strengthening treatment at a constant temperature, with an increase in strengthening time, DOL increases in proportion to the square root of the time, and CS lowers. In chemical strengthening for confirming an increase in CS, DOL is preferably 20 μm or less.

The DOL value of the chemically strengthened glass of the present embodiment is preferably 6 μm or more, and more preferably 8 μm or more. In particular, when influenced by scratches during handling of the glass, it is preferably 10 μm or more. In order to enable cutting after the chemical strengthening treatment, the DOL value of the chemically strengthened glass is preferably 30 μm or less, more preferably 25 μm or less, and even more preferably 20 μm or less.

As one specific example of evaluation of the chemical strengthening characteristics of the glass of the present embodiment, regarding the surface stress generated when glasses are subjected to one-time chemical strengthening treatment with a molten salt of potassium nitrate having a purity of 99.8% at 435° C. for 200 minutes, according to sample preparation and evaluation methods shown in Reference Examples 1 and 2 described later, DOL is preferably 8 μm or more, more preferably 8.5 μm or more, and even more preferably 9 μm or more. CS at this time is preferably 700 MPa or more, more preferably 730 MPa or more, even more preferably 750 MPa or more, and yet more preferably 760 MPa or more.

In addition, regarding the surface stress generated when glasses produced according to the float process, whose top surfaces are not subjected to the dealkalization treatment, are subjected to one-time chemical strengthening treatment with a molten salt of potassium nitrate having a purity of 98% at 425° C. for 90 minutes, according to evaluation methods shown in Examples described later, DOL is preferably 6 μm or more, more preferably 6.5 μm or more, and even more preferably 6.8 μm or more. CS at this time is preferably 630 MPa or more, more preferably 640 MPa or more, even more preferably 650 MPa or more, and yet more preferably 655 MPa or more.

The depth of the compressive stress layer and the surface compressive stress value of the chemically strengthened glass of the present invention can be measured by using a surface stress meter (for example, FSM-6000 manufactured by Orihara industrial Co., Ltd.) or the like.

The glass of the present embodiment can be cut after the chemical strengthening treatment. Regarding the cutting method, scribing and braking with an ordinary wheel chip cutter are applicable, and cutting with a laser is also applicable. In order to maintain the glass strength, chamfering of the cut edges may be performed after the cutting. The chamfering may be a mechanical grinding process, or a method of processing with a chemical of hydrofluoric acid or the like may also be employed.

The chemically strengthened glass of the present invention preferably has at least one kind selected from the group consisting of potassium ions, silver ions, cesium ions and rubidium ions on a surface thereof. This induces the compressive stress on the surface to increase the strength of the glass. In addition, antimicrobial properties can be imparted by having silver ions on the surface.

The use of the chemically strengthened glass of the present invention is not particularly limited. It is suitable for use in a place where impact due to falling or contact with another material is anticipated, because of its high mechanical strength.

Specifically, for example, there are uses for protection of machines or machinery, such as cover glasses for display parts of mobile phones (including multi-functional information terminals such as smartphones), PHSs, PDAs, tablet type terminals, notebook-size personal computers, game machines, portable music-video players, e-book readers, electronic terminals, watches, cameras, GPSs or the like, cover glasses of monitors for touch panel operation of these instruments, cover glasses of cooking devices such as microwave ovens and oven toasters, top plates of electromagnetic cooking devices and the like, cover glasses of measuring instruments such as meters and gauges, and glass plates for reading parts of copying machines, scanners or the like.

In addition, for example, there are uses such as glasses for windows of buildings, houses, vehicles, ships, aircrafts and the like, cover glasses of domestic or industrial lighting equipment, signals, guide lights and electric bulletin boards, show cases, table tops, shelf boards and bulletproof glasses. There are uses of cover glasses for protection of solar cells and condensing glass materials for increasing the power generation efficiency of solar cells.

In particular, it is effective as a cover glass used in an apparatus for displaying images (image display apparatus).

### EXAMPLES

### (Evaluation Methods)

### (1) Glass Composition

Glass Composition was analyzed by X-ray fluorescence analysis.

### (2) Measurement of Bottom Surface SnO₂ Concentration

The bottom surface SnO₂ concentration was analyzed by etching the bottom surface by 10 μm with a hydrofluoric acid solution, quantifying the Sn concentration in the solution through ICP emission spectrometry to prepare a calibration curve, and using X-ray fluorescence analysis, based on this calibration curve.

### (3) Redox

Fe²⁺ was quantified through bipyridyl absorptiometry, and Fe²⁺/(Fe²⁺+Fe³⁺) was calculated from the total Fe₂O₃ value determined by X-ray fluorescence analysis.

### (4) Refractive Index

Refractive Index was measured by a spectrometer using an angle of minimum deviation method.

### (5) Specific Gravity

The specific gravity was measured according to the Archimedes' method.

### (6) Thermal Expansion Coefficient

The thermal expansion coefficient was determined as a mean linear thermal expansion coefficient at 50 to 350° C. by thermomechanical analysis (TMA).

### (7) Glass Transition Point (T_{g})

The glass transition point was measured by TMA.

### (8) Strain Point and Annealing Point

These were measured by a fiber elongation method.

### (9) High-Temperature Viscosity

The temperature (T₂) at which the viscosity is 10² dPa·s and the temperature (T₄) at which the viscosity is 10⁴ dPa·s were measured by using a rotational viscometer.

### (10) Devitrification Temperature (T_{L})

Regarding the devitrification temperature, the glass was ground into glass grains of about 2 mm in a mortar, and the glass grains were placed side by side on a platinum boat, and heat-treated at intervals of 5° C. for 24 hours in a temperature gradient furnace. The maximum value of the temperature of the glass grains in which crystals are deposited is referred to as the devitrification temperature.

### (11) Surface Compressive Stress (CS) and Depth of Compressive Stress Layer (DOL)

The surface compressive stress and the depth of the compressive stress layer were measured by using a surface stress meter FSM-6000 manufactured by Orihara industrial Co., Ltd.

### (12) Photoelastic Constant

Photoelastic Constant was measured according to a disc compression method (“Measurement of Photoelastic Constant of Glass for Chemical Strengthening by Circular Plate Compression Method”, Ryosuke Yokota, Journal of Ceramic Society of Japan, 87 [10], 1979, pp. 519-522)

### (13) Warpage

The warpage was measured with a flatness tester type FT17V2 manufactured by Nidek Co., Ltd.

First, prior to Examples, Reference Examples 1 and 2 are described which relate to chemically strengthened glasses obtained by preparing glasses for chemical strengthening each having a glass composition within the range specified in the present invention in a crucible and then subjecting them to the chemical strengthening treatment in a laboratory.

### Reference Example 1

Glass raw materials having been commonly used, such as silica sand, soda ash, dolomite, feldspar, salt cake, other oxides, carbonates and hydroxides, were appropriately selected so as to obtain the composition represented by mass percentage based on oxides as described in Table 1, and weighed to be 1 kg as a glass. However, about twice the amount of salt cake was introduced in terms of the SO₃ amount. The weighed raw materials were mixed, placed in a platinum crucible, introduced into a resistance heating type electric furnace at 1480° C., and melted for 3 hours, followed by refining and homogenization.

The molten glass obtained was cast into a mold material, and retained at a temperature of T_{g}+50° C. for 1 hour. Thereafter, it was cooled to room temperature at a rate of 0.5° C./min to obtain several glass blocks. For a sample to be subjected to the chemical strengthening treatment, this block was cut and polished, and finally, both surfaces thereof were finished to mirror surfaces to obtain a tabular glass having a size of 30 mm×30 mm and a sheet thickness of 1.0 mm.

In Table 1, Examples 1-1 to 1-8 are Reference Examples having glass compositions falling within the range specified in the present invention. The results of composition analysis of the resulting glasses according to X-ray fluorescence analysis are shown in Table 1. In addition, the specific gravity, the thermal expansion coefficient, the glass transition point, the strain point, the high-temperature viscosity and the devitrification temperature of these glasses are shown in Table 1. In Table 1, the values in parentheses are values determined by regression calculation from the compositions.

The glasses described in Table 1 were each immersed in a molten salt of potassium nitrate having a purity of 99.8% at 435° C. for 200 minutes in the laboratory to perform the chemical strengthening treatment. Regarding each glass after the chemical strengthening treatment, the surface compressive stress CS (unit: MPa) and the depth of the compressive stress layer DOL (unit: μm) were measured by using a surface stress meter FSM-6000 manufactured by Orihara industrial Co., Ltd. The photoelastic constant, the refractive index and the results of CS and DOL are shown in relevant columns of Table 1.

The glass melted in a crucible generally has the CS value that is 100 MPa or more higher than the CS value of the float-formed glass. As one of the causes of this, it is considered because the glass melted in an electric furnace is decreased in the water content in the glass as compared with the glass melted by firing heavy oil or gas.

As another cause, it is considered that the crucible glass is decreased in fictive temperature because of its slower cooling rate, and increased in density even in the same composition, which causes CS to increase. The DOL value is not influenced by a microstructure of the glass, and therefore, the difference in the DOL value due to the annealing rate between the crucible melted glass and the float-formed glass is small as compared with CS.

In addition, the chemical strengthening treatment performed in a laboratory generally produces higher CS values than the chemical strengthening treatment industrially performed. It is considered that this is because the chemical strengthening treatment is repeated using the same molten salt in the industrial production, so that the molten salt is contaminated to increase the sodium concentration in the potassium nitrate salt, resulting in lowering of processing efficiency. In the laboratory, the potassium nitrate salt less contaminated is used, and therefore, the CS value is increased.

TABLE 1

| | | Ex. 1-1 | Ex. 1-2 | Ex. 1-3 | Ex. 1-4 | Ex. 1-5 | Ex. 1-6 | Ex. 1-7 | Ex. 1-8 |
|---|---|---|---|---|---|---|---|---|---|
| (mass %) | SiO₂ | 68.40 | 67.90 | 68.20 | 68.10 | 69.40 | 69.40 | 69.60 | 69.50 |
| | Al₂O₃ | 5.11 | 5.19 | 5.21 | 5.22 | 4.72 | 4.64 | 4.70 | 4.69 |
| | MgO | 4.12 | 4.13 | 3.68 | 4.25 | 4.54 | 4.47 | 3.99 | 4.60 |
| | CaO | 6.95 | 6.98 | 7.49 | 6.93 | 7.50 | 7.43 | 7.99 | 7.41 |
| | Na₂O | 14.90 | 15.00 | 15.00 | 15.10 | 13.50 | 13.20 | 13.30 | 13.40 |
| | K₂O | 0.17 | 0.57 | 0.17 | 0.17 | 0.16 | 0.52 | 0.16 | 0.16 |
| | TiO₂ | 0.11 | 0.11 | 0.11 | 0.11 | 0.10 | 0.10 | 0.11 | 0.10 |
| | Fe₂O₃ | 0.107 | 0.104 | 0.105 | 0.104 | 0.101 | 0.100 | 0.101 | 0.103 |
| | SO₃ | 0.05 | 0.06 | 0.06 | 0.06 | 0.05 | 0.06 | 0.05 | 0.04 |

| | | | | | | | | |
|---|---|---|---|---|---|---|---|---|
| (Na₂O + K₂O)/Al₂O₃ | 2.95 | 3.00 | 2.91 | 2.93 | 2.89 | 2.96 | 2.86 | 2.89 |
| (Na₂O + K₂O + MgO + CaO)/Al₂O₃ | 5.12 | 5.14 | 5.06 | 5.07 | 5.44 | 5.52 | 5.41 | 5.45 |
| (Na₂O + CaO)/Al₂O₃ | 4.28 | 4.24 | 4.32 | 4.22 | 4.45 | 4.45 | 4.53 | 4.44 |
| MgO/(MgO + CaO) | 0.37 | 0.37 | 0.33 | 0.38 | 0.38 | 0.38 | 0.33 | 0.38 |
| Specific Gravity | 2.501 | 2.502 | 2.504 | 2.501 | 2.498 | 2.498 | 2.500 | 2.498 |
| Thermal Expansion Coefficient | 92 | 94 | 93 | 92 | 87 | 88 | 88 | 87 |
| (10⁻⁷° C.⁻¹) | | | | | | | | |
| Glass Transition Point (° C.) | 556 | 554 | 557 | 557 | 568 | 564 | 567 | 567 |
| Strain Point (° C.) | (518) | (517) | (521) | (518) | (526) | (525) | (530) | (526) |
| T₂ (° C.) | 1455 | (1476) | (1478) | (1480) | 1471 | (1488) | (1489) | (1492) |
| T₄ (° C.) | 1042 | (1042) | (1043) | (1045) | 1058 | (1057) | (1057) | (1059) |
| T_{L} (° C.) | 1015 | 1005 | 1015 | 1020 | 1065 | 1060 | 1045 | 1070 |
| T₄-T_{L} (° C.) | 27 | — | — | — | −7 | — | — | — |
| Photoelastic Constant (nmcm/MPa) | (26.9) | (26.8) | (26.9) | (26.9) | (27.1) | (27.0) | (27.0) | (27.1) |
| Refractive Index | (1.5149) | (1.5151) | (1.5153) | (1.5148) | (1.5149) | (1.5152) | (1.5154) | (1.5148) |
| CS (MPa) | 798 | 796 | 798 | 805 | 792 | 762 | 791 | 788 |
| DOL (μm) | 11.15 | 11.5 | 10.9 | 11.1 | 9.1 | 9.2 | 9.1 | 9.1 |

A float-formed soda lime glass having a sheet thickness of 1.1 mm was subjected to the chemical strengthening treatment in the laboratory under the same conditions as the glasses of Table 1. As a result, CS was about 600 MPa, and DOL was about 9 As shown in Table 1, even considering comparatively high CS of the crucible molten glass, the glasses of Examples 1-1 to 1-4 were higher in the CS value than the ordinary soda lime glass, and also about 20% increased in the DOL value. In addition, the glasses of Examples 1-5 to 1-8 were similarly higher in the CS value than the ordinary soda lime glass, and equivalent in the DOL value thereto.

### Reference Example 2

Glass raw materials commonly used, such as silica sand, soda ash, dolomite, feldspar, salt cake, other oxides, carbonates and hydroxides, were appropriately selected so as to obtain the composition represented by mass percentage based on oxides as shown in Table 2, and weighed to be 500 g as a glass. However, about twice the amount of salt cake was introduced in terms of the SO₃ amount. The weighed raw materials were mixed, placed in a platinum crucible, introduced into a resistance heating type electric furnace at 1480° C., and melted for 3 hours, followed by refining and homogenization.

The molten glass obtained was cast into a mold material, formed into a tabular shape having a sheet thickness of about 10 mm, and retained at a temperature of 600° C. for 1 hour. Thereafter, it was cooled to room temperature at a rate of 1° C./min. For a sample to be subjected to the chemical strengthening treatment, this sheet was cut and polished, and finally, both surfaces thereof were finished to mirror surfaces to obtain a tabular glass having a size of 50 mm×50 mm and a sheet thickness of 3 mm.

The specific gravity, the thermal expansion coefficient, the strain point, T₂ and T₄ shown in Table 2 are values determined by regression calculation from the glass compositions shown in Table 2.

The glasses described in Table 2 were each immersed in a molten salt of potassium nitrate having a purity of 99.8% at 435° C. for 200 minutes in the laboratory to perform the chemical strengthening treatment. Regarding each glass after the chemical strengthening treatment, the surface compressive stress CS (unit: MPa) and the depth of the compressive stress layer DOL (unit: μm) were measured. The photoelastic constant, the refractive index and the results of CS and DOL are shown in relevant columns of Table 2.

It is as described in Reference Example 1 that the glass melted in a crucible generally has the CS value that is 100 MPa or more higher than the CS value of the float-formed glass. In Example 2-1, glass raw materials having an ordinary soda lime glass composition were used for comparison, and this is Comparative Reference Example. Examples 2-2 to 2-13 are Reference Examples having glass compositions falling within the range specified in the present invention.

TABLE 2

| | | Ex. | Ex. | Ex. | Ex. | Ex. | Ex. | Ex. |
|---|---|---|---|---|---|---|---|---|
| | | 2-1 | 2-2 | 2-3 | 2-4 | 2-5 | 2-6 | 2-7 |
| (mass %) | SiO₂ | 71.76 | 69.23 | 68.20 | 67.16 | 69.38 | 68.83 | 69.38 |
| | Al₂O₃ | 1.81 | 4.00 | 5.00 | 6.00 | 4.00 | 4.50 | 4.00 |
| | MgO | 4.49 | 4.34 | 3.88 | 3.41 | 4.69 | 4.66 | 5.69 |
| | CaO | 8.14 | 7.50 | 7.50 | 7.50 | 7.50 | 7.50 | 6.50 |
| | Na₂O | 13.15 | 14.59 | 15.09 | 15.59 | 13.50 | 13.50 | 13.50 |
| | K₂O | 0.27 | 0.00 | 0.00 | 0.00 | 0.56 | 0.63 | 0.56 |
| | TiO₂ | 0.058 | 0.03 | 0.03 | 0.03 | 0.078 | 0.081 | 0.078 |
| | Fe₂O₃ | 0.101 | 0.1 | 0.1 | 0.1 | 0.10 | 0.10 | 0.10 |
| | SO₃ | 0.22 | 0.202 | 0.202 | 0.202 | 0.20 | 0.20 | 0.20 |

| | | | | | | | |
|---|---|---|---|---|---|---|---|
| (Na₂O + K₂O)/Al₂O₃ | 7.41 | 3.65 | 3.02 | 2.60 | 3.51 | 3.14 | 3.51 |
| (Na₂O + K₂O + MgO + CaO)/Al₂O₃ | 14.39 | 6.61 | 5.29 | 4.42 | 6.56 | 5.84 | 6.56 |
| (Na₂O + CaO)/Al₂O₃ | 11.76 | 5.52 | 4.52 | 3.85 | 5.25 | 4.67 | 5.00 |
| MgO/(MgO + CaO) | 0.36 | 0.37 | 0.34 | 0.31 | 0.38 | 0.38 | 0.47 |
| Specific Gravity | 2.498 | 2.506 | 2.510 | 2.515 | 2.504 | 2.506 | 2.498 |
| Thermal Expansion Coefficient | 86.5 | 90.2 | 91.8 | 93.5 | 88.2 | 88.5 | 87.6 |
| (10⁻⁷° C.⁻¹) | | | | | | | |
| Strain Point (° C.) | 521 | 519 | 521 | 523 | 522 | 524 | 516 |
| T₂ (° C.) | 1466 | 1470 | 1474 | 1478 | 1479 | 1482 | 1482 |
| T₄ (° C.) | 1045 | 1043 | 1042 | 1041 | 1052 | 1054 | 1055 |
| Photoelastic Constant | 26.9 | 26.8 | 26.8 | 26.8 | 26.9 | 26.9 | 27.0 |
| (nmcm/MPa) | | | | | | | |
| Refractive Index | 1.5143 | 1.5153 | 1.5158 | 1.5163 | 1.5154 | 1.5159 | 1.5145 |
| CS (MPa) | 739 | 810 | 806 | 816 | 812 | 847 | 831 |
| DOL (μm) | 8.7 | 10.1 | 11.1 | 12.0 | 10.3 | 10.5 | 10.3 |

| | | Ex. | Ex. | Ex. | Ex. | Ex. | Ex. |
|---|---|---|---|---|---|---|---|
| | | 2-8 | 2-9 | 2-10 | 2-11 | 2-12 | 2-13 |
| (mass %) | SiO₂ | 69.38 | 70.50 | 70.04 | 70.11 | 69.72 | 69.38 |
| | Al₂O₃ | 4.00 | 4.00 | 4.50 | 4.00 | 4.50 | 4.00 |
| | MgO | 4.99 | 3.50 | 3.38 | 4.00 | 3.90 | 4.57 |
| | CaO | 7.00 | 7.20 | 7.00 | 7.00 | 6.80 | 7.32 |
| | Na₂O | 13.70 | 13.80 | 14.00 | 13.90 | 14.00 | 13.80 |
| | K₂O | 0.56 | 0.63 | 0.71 | 0.63 | 0.71 | 0.56 |
| | TiO₂ | 0.078 | 0.065 | 0.068 | 0.065 | 0.068 | 0.078 |
| | Fe₂O₃ | 0.10 | 0.10 | 0.10 | 0.10 | 0.10 | 0.10 |
| | SO₃ | 0.20 | 0.20 | 0.20 | 0.20 | 0.20 | 0.20 |

| | | | | | | |
|---|---|---|---|---|---|---|
| (Na₂O + K₂O)/Al₂O₃ | 3.59 | 3.56 | 3.61 | 3.27 | 3.63 | 3.27 |
| (Na₂O + K₂O + MgO + CaO)/Al₂O₃ | 6.56 | 6.56 | 6.28 | 5.58 | 6.38 | 5.65 |
| (Na₂O + CaO)/Al₂O₃ | 5.28 | 5.18 | 5.25 | 4.67 | 5.23 | 4.62 |
| MgO/(MgO + CaO) | 0.38 | 0.42 | 0.33 | 0.33 | 0.36 | 0.36 |
| Specific Gravity | 2.503 | 2.501 | 2.494 | 2.494 | 2.495 | 2.495 |
| Thermal Expansion Coefficient | 89.1 | 88.6 | 88.7 | 89.5 | 89.1 | 89.5 |
| (10⁻⁷° C.⁻¹) | | | | | | |
| Strain Point (° C.) | 520 | 518 | 522 | 522 | 519 | 520 |
| T₂ (° C.) | 1478 | 1480 | 1498 | 1502 | 1491 | 1498 |
| T₄ (° C.) | 1050 | 1052 | 1054 | 1056 | 1053 | 1055 |
| Photoelastic Constant | 26.9 | 27.0 | 27.2 | 27.2 | 27.1 | 27.1 |
| (nmcm/MPa) | | | | | | |
| Refractive Index | 1.5150 | 1.5148 | 1.5124 | 1.5123 | 1.5129 | 1.5128 |
| CS (MPa) | 785 | 805 | 765 | 768 | 774 | 783 |
| DOL (μm) | 10.4 | 10.3 | 11.8 | 13.2 | 11.7 | 12.9 |

As shown in Table 2, the glasses of Examples 2-2 to 2-13 were high in the CS value as compared with Example 2-1, and some thereof were about 10-40% increased in the DOL value.

As shown in Reference Example 1 and Reference Example 2, it has been known that it is possible to increase the strength as compared with the conventional soda lime glass, by applying the chemical strengthening treatment to the glasses having the glass compositions within the range specified in the present invention.

Subsequently, Examples of the present invention are described.

### Examples

Glass sheets having the compositions as represented by mass percentage based on oxides as shown in Table 3 were produced according to a float process. The compositions in the table are analysis values obtained by X-ray fluorescence analysis. Silica sand, soda ash, dolomite, feldspar and salt cake were used as glass raw materials, melted by natural gas firing, and formed into a glass ribbon so as to have a sheet thickness of 0.55 to 18 mm in a float bath.

Example 1 is a glass of the present invention. Example 2 is an ordinary soda lime glass for comparison. The ordinary glass was also formed into a glass ribbon so as to have a sheet thickness of 0.55 to 1.8 mm. Both of Examples 1 and 2 are samples in a state where the dealkalization treatment is not performed onto top surfaces thereof

The measured values of the redox, the specific gravity, the thermal expansion coefficient, the glass transition point, the strain point, the annealing point, the high-temperature viscosity, the devitrification temperature, the photoelastic constant and the refractive index of the respective glasses of Example 1 and Example 2 are shown in Table 3.

TABLE 3

| | | Ex. 1 | Ex. 2 |
|---|---|---|---|
| (mass %) | SiO₂ | 68.50 | 71.80 |
| | Al₂O₃ | 5.01 | 1.88 |
| | MgO | 4.12 | 4.58 |
| | CaO | 7.21 | 7.84 |
| | Na₂O | 14.60 | 13.30 |
| | K₂O | 0.24 | 0.32 |
| | TiO₂ | 0.03 | 0.03 |
| | Fe₂O₃ | 0.083 | 0.105 |
| | SO₃ | 0.17 | 0.18 |

| | | |
|---|---|---|
| (Na₂O + K₂O)/Al₂O₃ | 2.96 | 7.24 |
| (Na₂O + K₂O + MgO + CaO)/Al₂O₃ | 5.22 | 13.85 |
| (Na₂O + CaO)/Al₂O₃ | 4.35 | 11.24 |
| MgO/(MgO + CaO) | 0.36 | 0.37 |
| Redox (%) | 28.7 | 27.8 |
| Specific Gravity | 2.500 | 2.497 |
| Thermal Expansion Coefficient (10⁻⁷° C.⁻¹) | 91 | 89 |
| Glass Transition Point (° C.) | 552 | 547 |
| Annealing Point (° C.) | 553 | 550 |
| Strain Point (° C.) | 512 | 509 |
| T₂ (° C.) | 1474 | 1466 |
| T₄ (° C.) | 1043 | 1039 |
| T_{L} (° C.) | 1025 | 1020 |
| T₄ − T_{L} (° C.) | 18 | 19 |
| Photoelastic Constant (nmcm/MPa) | 27.1 | 27.1 |
| Refractive Index | 1.518 | 1.518 |

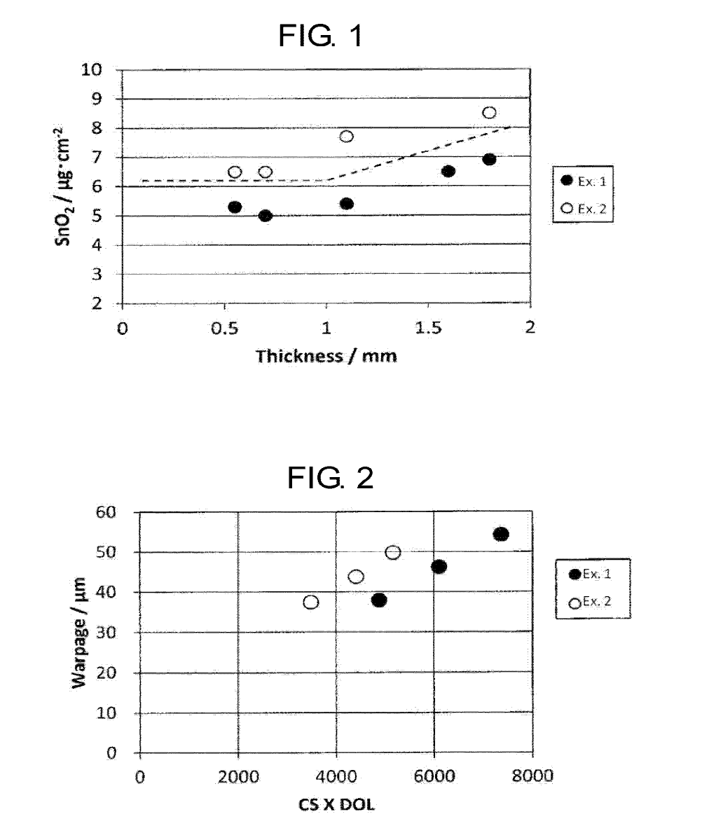

The bottom surface SnO₂ concentration of each glass of Example 1 and Example 2 is shown by the formed thickness in Table 4. The relationship between the thickness of the glass sheet and the bottom surface SnO₂ concentration is shown in FIG. 1. From FIG. 1, it is known that the SnO₂ concentration is approximately constant regardless of the thickness in the glass sheet of 1 mm or less in thickness, and that the SnO₂ concentration increases depending on the thickness in the glass sheet of more than 1 mm in thickness. In this Example, the thickness of the glass sheet of 1 mm or less is changed by varying the flow rate of the molten glass to the float bath and making the drawing speed (conveying speed) of the glass ribbon approximately constant, and therefore, as the residence time of the glass ribbon in the float bath becomes approximately constant when the sheet thickness is 1 mm or less, the SnO₂ concentration becomes approximately constant. On the other hand, when the sheet thickness is more than 1 mm, the thickness is changed by making constant the flow rate of the molten glass to the float bath and varying the drawing speed (conveying speed) of the grass ribbon. The residence time of the glass ribbon in the float bath is increased with an increase in the thickness of the glass (corresponding to a decrease in the conveying speed of the glass ribbon). Therefore, the SnO₂ concentration is also increased depending on the thickness of the glass. It is known that in any thickness, the glass of Example 1 is lower in the bottom surface SnO₂ concentration than the glass of Example 2.

TABLE 4

| Thickness t of Glass Sheet (mm) | | 0.55 | 0.7 | 1.1 | 1.6 | 1.8 |
|---|---|---|---|---|---|---|
| SnO₂ Amount of Bottom Surface | Ex. 1 | 5.3 | 5.0 | 5.4 | 6.5 | 6.9 |
| (μg/cm²) | Ex. 2 | 6.5 | 6.5 | 7.7 | | 8.5 |

Each glass sheet formed to a thickness of 0.55 mm of Example 1 and Example 2 was cut into several 50 mm square sheets, thereby immersing in a molten salt of potassium nitrate having a purity of 98% at 425° C. for 90 to 240 minutes to perform one-time chemical strengthening treatment. Regarding each glass after the chemical strengthening treatment, the surface compressive stress CS (unit: MPa) and the depth of the compressive stress layer DOL (unit: μm) were measured by using a surface stress meter FSM-6000 manufactured by Orihara industrial Co., Ltd. In addition, the flatness of the 50 cm square sheet was measured, and the difference between the maximum value and the minimum value of the height was referred to as the value of warpage (unit: μm). CS, DOL, CS×DOL and the warpage are shown in Table 5. CS and DOL were measured on the glass top surface.

TABLE 5

| | Ex. 1 | | | | Ex. 2 | | | |
|---|---|---|---|---|---|---|---|---|
| Time | CS | DOL | CS × | Warpage | CS | DOL | CS × | Warpage |
| (min) | (MPa) | (μm) | DOL | (μm) | (MPa) | (μm) | DOL | (μm) |
| 90 | 668 | 7.3 | 4876 | 38 | 580 | 6 | 3480 | 37 |
| 150 | 649 | 9.4 | 6101 | 46 | 572 | 7.7 | 4404 | 44 |
| 240 | 640 | 11.5 | 7360 | 54 | 555 | 9.3 | 5162 | 50 |

As shown in Table 5, when the chemical strengthening treatment is performed under the same conditions, the CS and DOL values in Example 1 are larger than in Example 2. However, the warpage after chemical strengthening occurs due to the stress generated in the surface layer, that is, unbalance of CS×DOL. The relationship between CS×DOL and warpage is shown in FIG. 2. From FIG. 2, it is known that the glass of Example 1 is smaller in warpage to CS×DOL than the glass of Example 2. That is, the glass of the present invention is a glass in which the warpage to the magnitude of the stress is less likely to occur as compared with the ordinary soda lime glass, when subjected to the same chemical strengthening treatment.

The redox of each glass of Example 1 and Example 2 is shown in Table 3. The redox of the glass of Example 1 is slightly high as compared with that of the glass of Example 2, but the difference therebetween is small. In other words, it is known that the glass of the present invention has been melted at substantially the same temperature as the ordinary soda lime glass.

The refractive index R₁ at room temperature (25° C.) of the glass sheet of Example 1, the refractive index R₂ of a glass sheet measured at room temperature, which has been obtained by re-heating the same glass sheet at 600° C., allowing it to stand for 1 hour, and then re-annealing it to room temperature (25° C.) at a rate of 1° C./min, and the difference (R₂−R₁) therebetween are shown in Table 6. The measurement has been made in the case where the thickness t of the glass sheet is 0.55 mm, 0.7 mm or 1.1 mm. The glass sheet of any thickness shows a difference in the refractive index of 0.0012 or less, and it is known that annealing is performed at a sufficiently slow cooling rate.

TABLE 6

| Thickness t of Glass Sheet (mm) | | 0.55 | 0.7 | 1.1 |
|---|---|---|---|---|
| Refractive | After Float Production (R₁) | 1.51808 | 1.51808 | 1.51822 |
| Index | After Re-annealing (R₂) | 1.51905 | 1.51901 | 1.51907 |
| | Difference (R₂ − R₁) | 0.00097 | 0.00094 | 0.00086 |

### INDUSTRIAL APPLICABILITY

The chemically strengthened glass of the present invention obtained by chemically strengthening the glass for chemical strengthening of the present invention can be utilized for cover glasses in display devices, especially in touch panel displays. In addition, it can also be utilized in multilayer glasses for buildings and houses, solar cell substrates and the like.

While the present invention has been described in detail with reference to specific embodiments thereof, it will be apparent to one skilled in the art that various changes and modifications can be made therein without departing from the spirit and scope of the present invention.

The present application is based on Japanese Patent Application (Application No. 2014-244446) filed on Dec. 2, 2014, and the entire thereof is incorporated herein by reference.

1. A glass for chemical strengthening that is a float-formed glass for chemical strengthening comprising, as represented by mass percentage based on oxides, from 65 to 72% of SiO₂, from 3.6 to 8.6% of Al₂O₃, from 3.3 to 6% of MgO, from 6.5 to 9% of CaO, from 13 to 16% of Na₂O and from 0 to 0.9% of K₂O, wherein (Na₂O+K₂O)/Al₂O₃ is from 2.2 to 5, and having a sheet thickness (t) of 0.1 mm or more and 2 mm or less, wherein a SnO₂ amount of a bottom surface in an unpolished state of the glass for chemical strengthening is 6.2 μg/cm² or less (0.1≦t≦1 mm) or (2t+4.2) μg/cm² or less (1<t≦2 mm).

2. The glass for chemical strengthening according to claim 1, wherein R₂−R₁ is 0.0012 or less when a refractive index of the glass for chemical strengthening at room temperature is assumed as R₁ and a refractive index at room temperature after the glass for chemical strengthening heated to a temperature equivalent to or higher than an annealing point is annealed to room temperature at a rate of 1° C./min is assumed as R₂.

3. A glass for chemical strengthening that is a float-formed glass for chemical strengthening comprising, as represented by mass percentage based on oxides, from 65 to 72% of SiO₂, from 3.6 to 8.6% of Al₂O₃, from 3.3 to 6% of MgO, from 6.5 to 9% of CaO, from 13 to 16% of Na₂O and from 0 to 0.9% of K₂O, wherein (Na₂O+K₂O)/Al₂O₃ is from 2.2 to 5, and having a sheet thickness (t) of 0.1 mm or more and 2 mm or less, wherein the glass for chemical strengthening is a glass for chemical strengthening cooled in an annealing furnace of a float production apparatus so that R₂−R₁ is 0.0012 or less when a refractive index of the glass for chemical strengthening at room temperature is assumed as R₁ and a refractive index at room temperature after the glass for chemical strengthening heated to a temperature equivalent to or higher than an annealing point is annealed to room temperature at a rate of 1° C./min is assumed as R₂, and a SnO₂ amount of a bottom surface in an unpolished state thereof is 6.2 μg/cm² or less (0.1≦t≦1 mm) or (2t+4.2) μg/cm² or less (1<t≦2 mm).

4. The glass for chemical strengthening according to claim 1, wherein (Na₂O+K₂O+MgO+CaO)/Al₂O₃ is 8.9 or less.

5. The glass for chemical strengthening according to claim 1, wherein MgO/(MgO+CaO) is 0.27 or more.

6. The glass for chemical strengthening according to claim 1, further comprising, as represented by mass percentage based on oxides, from 0.01 to 0.2% of iron oxide in terms of Fe₂O₃, wherein a redox (Fe²⁺/(Fe²⁺+Fe³⁺)×100) is 18% or more and 35% or less.

7. A method for producing a glass for chemical strengthening, the method comprising melting a glass, float-forming the molten glass into a glass sheet, and thereafter annealing the glass sheet, so as to obtain the glass for chemical strengthening according to claim 1.

8. A chemically strengthened glass obtained by chemically strengthening the glass for chemical strengthening according to claim 1.

9. An image display apparatus equipped with the chemically strengthened glass according to claim 8.

10. A method for producing a glass for chemical strengthening, the method comprising:
a melting step of melting a glass comprising, as represented by mass percentage based on oxides, from 65 to 72% of SiO₂, from 3.6 to 8.6% of Al₂O₃, from 3.3 to 6% of MgO, from 6.5 to 9% of CaO, from 13 to 16% of Na₂O and from 0 to 0.9% of K₂O, wherein (Na₂O+K₂O)/Al₂O₃ is from 2.2 to 5;
a forming step of forming the molten glass into a glass ribbon having a sheet thickness (t) of 0.1 mm or more and 2 mm or less with a float production apparatus;
an annealing step of annealing the glass ribbon formed; and
a cutting step of cutting the glass ribbon annealed,
wherein in the forming step, forming is performed in a float forming furnace so that a SnO₂ amount of a bottom surface in an unpolished state of the glass is 6.2 μg/cm² or less (0.1≦t≦1 mm) or (2t+4.2) μg/cm² or less (1<t≦2 mm), and
in the annealing step, cooling is performed in an annealing furnace so that R₂−R₁ is 0.0012 or less when a refractive index of the glass at room temperature is assumed as R₁ and a refractive index at room temperature after the glass heated to a temperature equivalent to or higher than an annealing point is annealed to room temperature at a rate of 1° C./min is assumed as R₂.

11. The method for producing a glass for chemical strengthening according to claim 10, wherein the glass further comprises, as represented by mass percentage based on oxides, from 0.01 to 0.2% of iron oxide in terms of Fe₂O₃, and in the melting step, the glass is melted so that (Fe²⁺/(Fe²⁺+Fe³⁺)×100) is 18% or more and 35% or less.

12. The method for producing a glass for chemical strengthening according to claim 10, wherein (Na₂O+K₂O+MgO+CaO)/Al₂O₃ is 8.9 or less.

13. The method for producing a glass for chemical strengthening according to claim 10, wherein MgO/(MgO+CaO) is 0.27 or more.
